(19) United States
(12) Patent Application Publication
(10) Pub. No.: US 2026/0171629 A1
(43) Pub. Date: Jun. 18, 2026

(54) FOIL TO TERMINAL PLATE INTERACE SYSTEM FOR PRISMATIC CANBATTERY CELLS

(71) Applicant: GM GLOBAL TECHNOLOGY OPERATIONS LLC, Detroit, MI (US)

(72) Inventors: Junjie MA, Novi, MI (US); Masoud MOHAMMADPOUR, Washington, MI (US); Teresa Jean RINKER, Royal Oak, MI (US); John Christian KALIL, Washington, MI (US); Matthew Arthur CELENTANO, Berkley, MI (US); Subrahmanyam GORIPARTI, Troy, MI (US); Blair E. CARLSON, Ann Arbor, MI (US); Ryan Curtis SEKOL, Grosse Pointe Woods, MI (US)

(21) Appl. No.: 18/978,641

(22) Filed: Dec. 12, 2024

(51) Int. Cl. H01M 50/54; H01M 50/103; H01M 50/15; H01M 50/533; H01M 50/536; H01M 50/566

(52) U.S. Cl. CPC H01M 50/54; H01M 50/103; H01M 50/15; H01M 50/533; H01M 50/536; H01M 50/566

(57) ABSTRACT

A prismatic battery cell includes a cell can having a plurality of walls including a base wall, a first side wall, a second side wall, and a rear wall that collectively form an electrode stack receiving zone, a cap is mounted to the cell can, the cap forming a top wall and includes a terminal. A plurality of electrodes is arranged in the electrode stack receiving zone. The plurality of electrodes include a plurality of terminal foils. An interface system includes a connector assembly joining the plurality of terminal foils with the terminal. The connector assembly includes a first connector member and a second connector member. The plurality of terminal foils is arranged between and joined to the first connector member and the second connector member.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of prismatic battery cells and, more particularly, to a foil to terminal plate interface system for a prismatic battery cell.

Prismatic battery cells include a cell can including a cap supporting a first, or cathode terminal and a second, or anode terminal. A number of battery cells are arranged in the cell can. Each battery cell includes a cathode foil terminal and an anode foil terminal. The cathode foil terminals are stacked and welded to a cathode terminal block and the anode foil terminals are stacked and welded to an anode terminal block. The cathode terminal block is mounted to the cap and connected with the cathode terminal and the anode terminal block is mounted to the cap and connected to the anode terminal.

### SUMMARY

A prismatic battery cell, in accordance with the present disclosure, includes a cell can including a plurality of walls that form an electrode stack receiving zone, a cap is mounted to the cell can, the cap includes a terminal. A plurality of electrodes is arranged in the electrode stack receiving zone. The plurality of electrodes include a plurality of terminal foils. An interface system includes a connector assembly joining the plurality of terminal foils with the terminal. The connector assembly includes a first connector member and a second connector member. The plurality of terminal foils is arranged between and joined to the first connector member and the second connector member.

In other features, the connector assembly is welded to the plurality of terminal foils.

In other features, an internal terminal plate is arranged in the electrode stack receiving zone mounted to the cap and electrically connected to the terminal, the connector assembly being electrically connected to the internal terminal plate.

In other features, the first connector member comprises a first L-shaped connector member including a first leg element and a second leg element, and the second connector member comprises a second L-shaped connector member including a third leg element and a fourth leg element, the plurality of terminal foils being arranged between the first leg element and the third leg element.

In other features, the second leg element and the fourth leg element are electrically connected to the terminal on the cap.

In other features, the second leg element includes a first length, and the fourth leg element includes a second length that is greater than the first length.

In other features, the fourth leg element is electrically connected to the terminal.

In other features, the fourth leg element includes a first end joined to the third leg element a second end electrically connected to the terminal, and a bend portion formed between the first end and the second end.

In other features, the bend portion includes a 180° bend.

In other features, a connector element is coupled to one of the first connector member and the second connector member with the terminal, the connector element including a first end joined to the one of the first connector member and the second connector member a second end electrically connected to the terminal, and a bend portion formed between the first end and the second end.

In other features, the bend portion includes a 180° bend.

A method of connecting electrodes to a terminal in a prismatic battery cell, in accordance with the present disclosure, includes positioning a plurality of terminal foils connected to an electrode stack between a first connector member and a second connector member, applying a clamping force to the plurality of terminal foils through the first connector member and the second connector member, connecting the plurality of terminal foils to the first connector member and the second connector member to form a connector assembly, and joining the connector assembly to a cap of the prismatic battery cell.

In other features, the method also includes attaching an internal terminal plate to the cap, the internal terminal plate being electrically connected with the terminal.

In other features, joining the connector assembly to the cap includes welding the connector assembly to the internal terminal plate.

In other features, positioning the terminal foils includes placing the terminal foils between a first leg element of a first L-shaped connector member and a third leg element of a second L-shaped connector member.

In other features, joining the connector assembly to the cap includes joining a second leg element of the first L-shaped connector member and a fourth leg element of the second L-shaped connector member to the terminal.

In other features, joining the connector assembly to the cap includes joining a fourth leg element of the second L-shaped connector member to the terminal, the fourth leg element including a 180° bend.

In other features, joining the connector assembly to the cap includes inverting the cap, joining a first end of a connector element to one of the first connector member and the second connector member, joining a second end of the connector element to the terminal on the cap, and bending the connector element to invert the cap.

In other features, joining the connector assembly to the terminal includes welding the connector assembly to a terminal block supported on the cap.

In other features, welding the connector assembly to the terminal block includes protecting one or more of the plurality of terminal foils and the electrode stack with one of a shielding gas and a clamp shield.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a front elevational view of a prismatic can battery cell including a foil to terminal plate interface system, in accordance with the present disclosure;

FIG. 2A depicts a connector assembly of the foil to terminal plate interface system connected to terminal foils, in accordance with the present disclosure;

FIG. 2B depicts the connector assembly joined to a terminal mounted to a cap of the prismatic can battery cell, in accordance with the present disclosure;

FIG. 3 depicts terminal foils clamped between a first connector member and a second connector member of the foil to terminal plate interface system, in accordance with the present disclosure;

FIG. 4A depicts the connector assembly being joined to the terminal, in accordance with an aspect of the present disclosure;

FIG. 4B depicts the connector assembly being joined to the terminal, in accordance with another aspect of the present disclosure;

FIG. 5 depicts a connector assembly including a first L-shaped connector member and a second L-shaped connector member, in accordance with the present disclosure;

FIG. 6A depicts the connector assembly of FIG. 5 joined to terminal foils, in accordance with the present disclosure;

FIG. 6B depicts the connector assembly of FIG. 6A joined to a terminal of the prismatic can battery cell, in accordance with the present disclosure;

FIG. 7A depicts a connector assembly including a first L-shaped connector member and a second L-shaped connector member, in accordance with another aspect of the present disclosure;

FIG. 7B depicts the second L-shaped connector member being joined to the terminal of the prismatic can battery cell, in accordance with the present disclosure;

FIG. 7C depicts the cap joined to the connector assembly of FIG. 7A, in accordance with the present disclosure;

FIG. 8A depicts a connector assembly including a connection member, in accordance with another aspect of the present disclosure;

FIG. 8B depicts the connection member being joined to the terminal of the prismatic can battery cell, in accordance with the present disclosure; and

FIG. 8C depicts the cap joined to the connector assembly of FIG. 8A, in accordance with the present disclosure.

In the drawings, reference numbers may be reused to identify similar and/or identical elements.

### DETAILED DESCRIPTION

The present disclosure presents a system for securing foil terminals to a cap assembly of a prismatic can battery cell. The system clamps the foil terminals between two connector members which are then welded to the cap. Clamping the foil terminals between the connector members ensures a deeper penetration of the weld through all foil terminal members so as to achieve a more robust terminal connection.

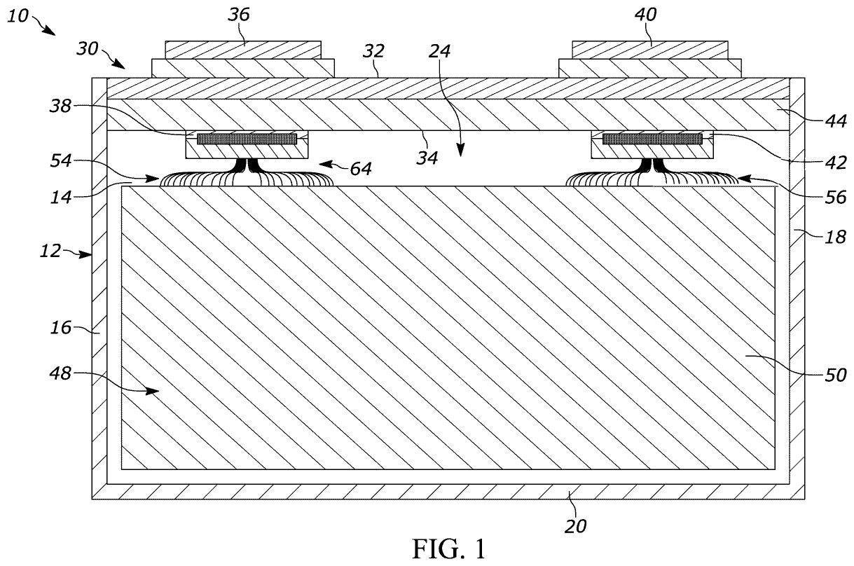

A prismatic can battery cell, in accordance with the present disclosure, is indicated generally at 10 in FIG. 1. Prismatic can battery cell 10 includes a cell can 12 having a front wall 14, a first side wall 16, a second side wall 18, a base wall 20, and a rear wall (not shown) that collectively form an electrode stack receiving zone 24. A cap 30 is positioned across electrode stack receiving zone 24. Cap 30 forms a top wall (not separately labeled) that includes an outer surface 32 and an inner surface 34.

A cathode terminal 36 is mounted to outer surface 32. Cathode terminal 36 includes a cathode terminal plate 38 arranged at inner surface 34 and exposed to electrode stack receiving zone 24. An anode terminal 40 is mounted to outer surface 32 of cap 30 spaced from cathode terminal 36. Anode terminal 40 includes an anode terminal plate 42 arranged at inner surface 34 and exposed to electrode stack receiving zone 24. An isolator 44 is arranged between cap 30 and cathode terminal 36 and anode terminal 40.

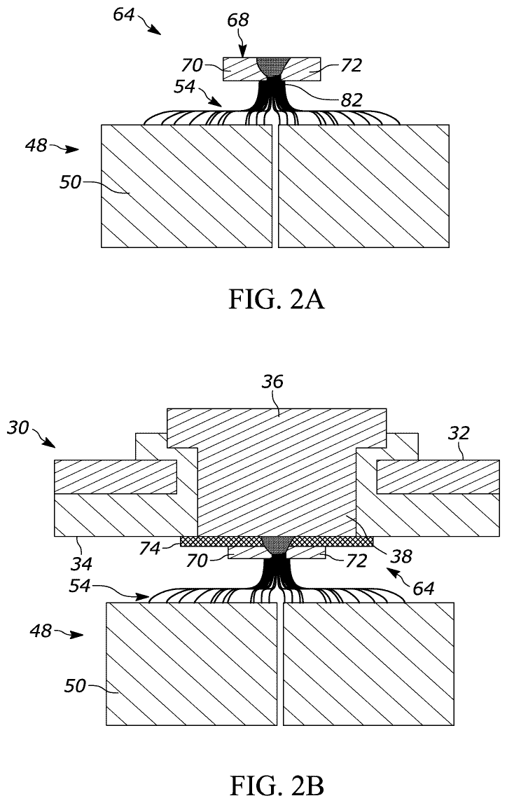

A plurality of electrodes 48 are arranged in electrode stack receiving zone 24. Plurality of electrodes 48 are arranged in an electrode stack 50 having cathode terminal foils 54 and anode terminal foils 56 that are joined to corresponding ones of cathode terminal plate 38 and anode terminal plate 42 in electrode stack receiving zone 24. Reference will now follow to FIGS. 2A and 2B in describing an interface system 64 used to join cathode terminal foils 54 to cathode terminal plate 38 with an understanding that a similar interface system may be used to join anode terminal foils 56 with anode terminal plate 42.

In accordance with the present disclosure, interface system 64 includes a connector assembly 68 that is bonded to cathode terminal foils 54. Connector assembly 68 includes a first connector member 70 and a second connector member 72 that flank and are bonded to cathode terminal foils 54 as shown in FIG. 2A. Once bonded to cathode terminal foils 54, connector assembly 68 is joined to cathode terminal plate 38 as shown in FIG. 2B. Cathode terminal plate 38 may form part of a riveted terminal system and include an inner terminal plate member 74 or may form part of a rivetless terminal system.

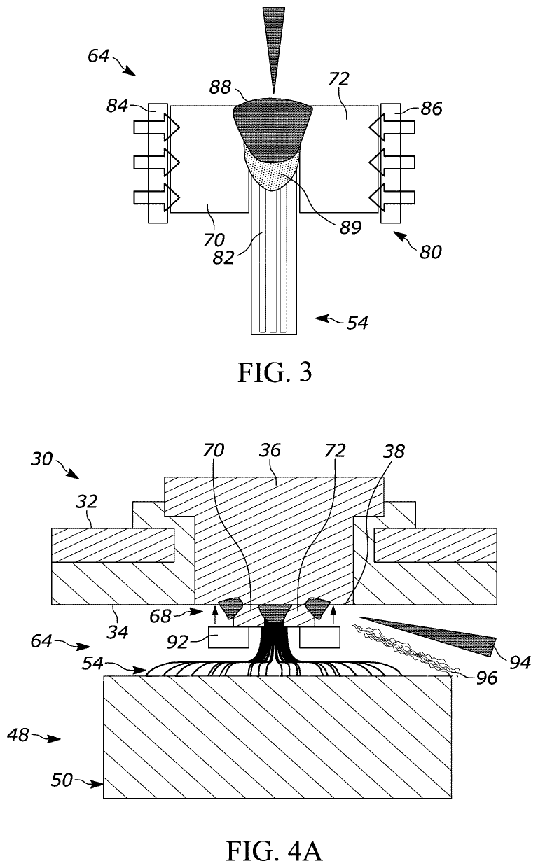

As shown in FIG. 3, cathode terminal foils 54 include terminal ends 82 that are arranged between first connector member 70 and second connector member 72. A clamping mechanism 80 including a first clamp element 84 and a second clamp element 86 apply a compressive force to terminal ends 82 of cathode terminal foils 54 through first connector member 70 and second connector member 72. Once compressed, first connector member 70 and second connector member 72 are welded to terminal ends 82 of cathode terminal foils 54 forming a bond having a fusion zone 88 and a diffusion zone 89. Clamping terminal ends 82 of cathode terminal foils 54 between first connector member 70 and second connector member 72 while welding ensures that fusion zone 88 is strong, clamping the terminal ends 82 also ensures that diffusion zone 89 extends deeply into the material to form a robust connection.

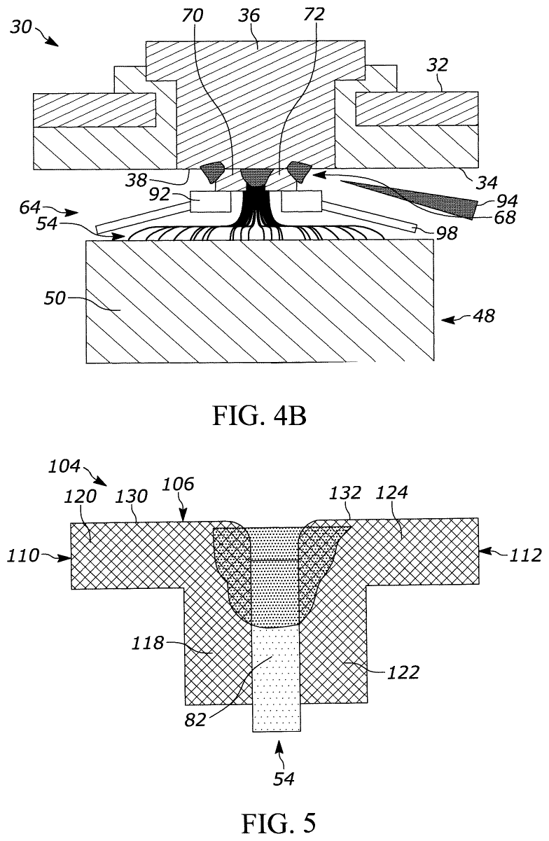

In accordance with an aspect of the present disclosure, connector assembly 68 is positioned against cathode terminal plate 38 by a clamp 92 and joined through a laser welding system 94 as shown in FIG. 4A. Welding may take place with a shielding gas stream 96 that protects cathode terminal foils 54 and electrode stack 50 from heat generated when joining connector assembly 68 to cathode terminal plate 38. In accordance with another aspect of the present disclosure depicted in FIG. 4B, a clamp shield 98 connected to clamp 92. Clamp shield 98 may provide supplemental protection for cathode terminal foils 54 and electrode stack 50 when joining connector assembly 68 to cathode terminal plate 38.

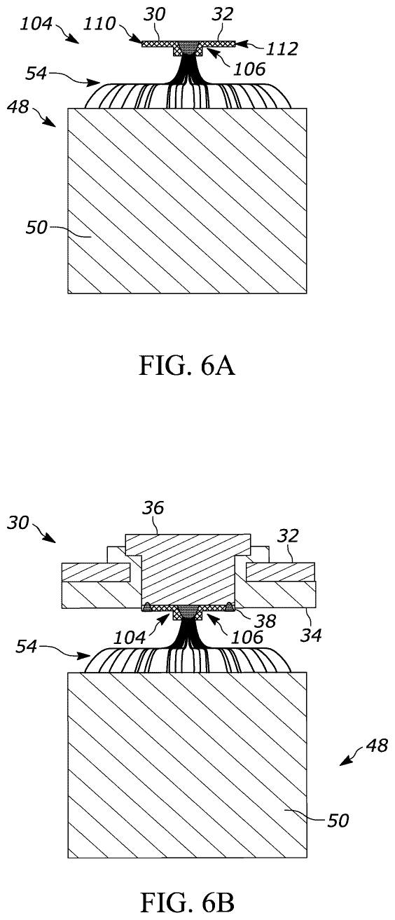

An interface system 104 in accordance with another aspect of the present disclosure is illustrated in FIG. 5. Interface system 104 includes a connector assembly 106 having a first L-shaped connector member 110 and a second L-shaped connector member 112. First L-shaped connector member 110 includes a first leg element 118 and a second leg element 120. Second L-shaped connector member 112 includes a third leg element 122 and a fourth leg element 124. Terminal ends 82 of cathode terminal foils are clamped between and joined to first leg element 118 and third leg element 122 as shown in FIG. 6A. Second leg element 120 includes a first bonding surface 130 and fourth leg element 124 includes a second bonding surface 132 that are joined to cathode terminal plate 38 through a welding process as shown in FIG. 6B.

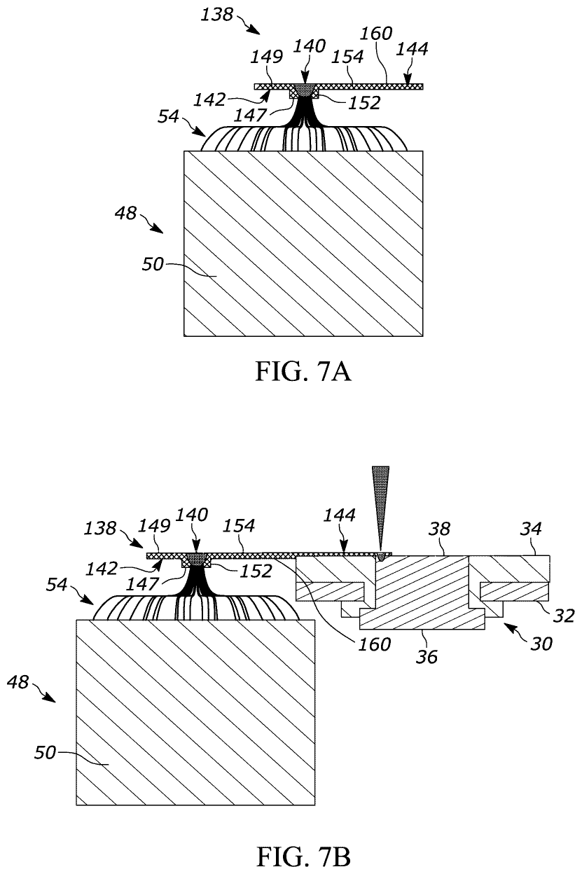

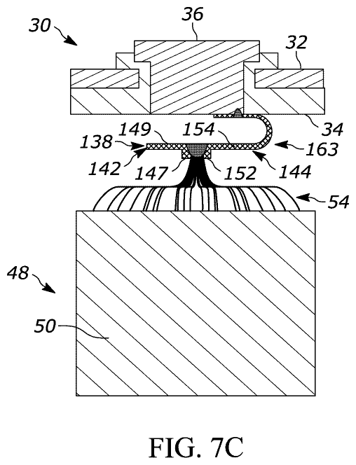

FIG. 7A depicts an interface system 138 in accordance with another aspect of the present disclosure. Interface system 138 includes a connector assembly 140 having a first L-shaped connector member 142 and a second L-shaped connector member 144. First L-shaped connector member 142 includes a first leg element 147 and a second leg element 149. Second L-shaped connector member 144 includes a third leg element 152 and a fourth leg element 154. Terminal ends 82 of cathode terminal foils 54 are clamped between first leg element 147 and third leg element 152.

In accordance with the present disclosure, second leg element 149 includes a first length and fourth leg element 154 includes a second length that is substantially longer than the first length. Fourth leg element 154 includes a bonding surface 160. With this construction, cap 30 may be inverted and positioned near to connector assembly 140 with fourth leg element 154 extending across cathode terminal plate 38 as shown in FIG. 7B. In this position, bonding surface 160 may be joining to cathode terminal plate 38 without heating cathode terminal foils 54. Once attached to cap 30, fourth leg element 154 may be manipulated to form a bend portion 163 having a 180° bend as shown in FIG. 7C. Bend portion 163 ensures that cap 30 is properly positioned when inserting electrode stack 50 into electrode stack receiving zone 24.

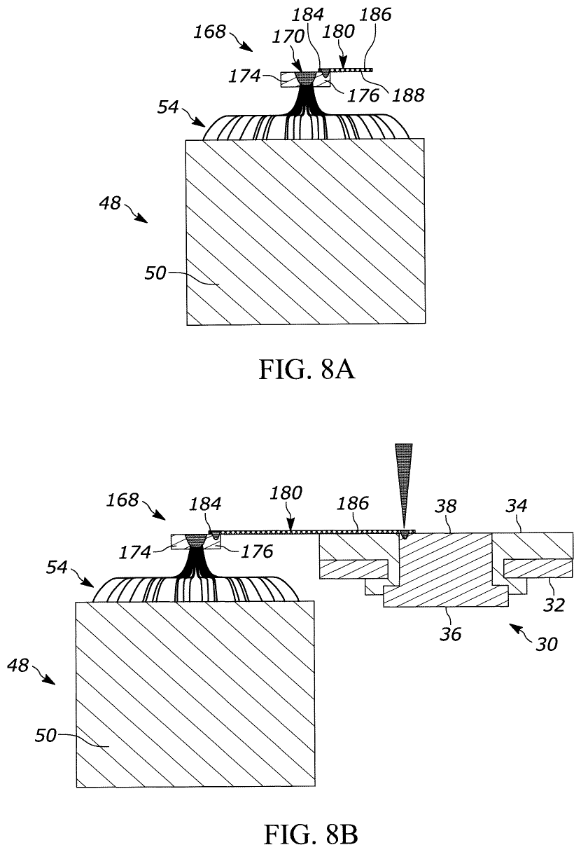

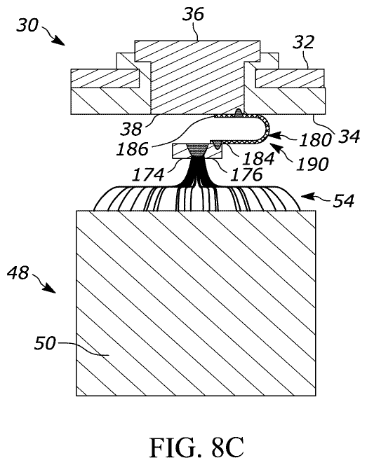

An interface system, in accordance with yet another aspect of the present disclosure, is indicated generally at 168 in FIG. 8A. Interface system 168 includes a connector assembly 170 having a first connector member 174 and a second connector member 176. A connector element 180 is mounted to connector assembly 170. Connector element 180 includes a first end 184 that is joined to second connector member 176, a second end 186, and a bonding surface 188 that is cantilevered.

In a manner similar to that discussed herein, cap 30 may be inverted and positioned near to connector assembly 170 with second end 186 of connector element 180 extending across cathode terminal plate 38 as shown in FIG. 8B. In this position, bonding surface 188 may be joined to cathode terminal plate 38 without heating cathode terminal foils 54. Once attached, cap 30 may be manipulated to form a bend portion 190 having a 180° bend in connector element 180 as shown in FIG. 8C. Bend portion 190 ensures that cap 30 is properly positioned when inserting electrode stack 50 into electrode stack receiving zone 24.

At this point, it should be understood that the present disclosure describes a number of systems that create a more robust connection between terminal foils and a battery terminal. Clamping the terminal foils between connector members while welding insures not only a good fusion zone but a weld the diffuses deeply into the material. The more robust connection enhances an overall operational envelope for the battery.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A prismatic battery cell comprising:
a cell can have a plurality of walls including a base wall, a first side wall, a second side wall, and a rear wall that collectively form an electrode stack receiving zone;
a cap mounted to the cell can, the cap forming a top wall including a terminal;
a plurality of electrodes arranged in the electrode stack receiving zone, the plurality of electrodes including a plurality of terminal foils; and
an interface system including a connector assembly joining the plurality of terminal foils with the terminal,
wherein the connector assembly includes a first connector member and a second connector member, the plurality of terminal foils being arranged between and joined to the first connector member and the second connector member.

2. The prismatic battery cell according to claim 1, wherein the connector assembly is welded to the plurality of terminal foils.

3. The prismatic battery cell according to claim 1, further comprising an internal terminal plate arranged in the electrode stack receiving zone mounted to the cap and electrically connected to the terminal, the connector assembly being electrically connected to the internal terminal plate.

4. The prismatic battery cell according to claim 1, wherein the first connector member comprises a first L-shaped connector member including a first leg element and a second leg element and the second connector member comprises a second L-shaped connector member including a third leg element and a fourth leg element, the plurality of terminal foils being arranged between the first leg element and the third leg element.

5. The prismatic battery cell according to claim 4, wherein the second leg element and the fourth leg element are electrically connected to the terminal on the cap.

6. The prismatic battery cell according to claim 4, wherein the second leg element includes a first length, and the fourth leg element includes a second length that is greater than the first length.

7. The prismatic battery cell according to claim 6, wherein the fourth leg element is electrically connected to the terminal.

8. The prismatic battery cell according to claim 7, wherein the fourth leg element includes a first end joined to the third leg element a second end electrically connected to the terminal, and a bend portion formed between the first end and the second end.

9. The prismatic battery cell according to claim 8, wherein the bend portion includes a 180° bend.

10. The prismatic battery cell according to claim 1, further comprising a connector element coupled to one of the first connector member and the second connector member with the terminal, the connector element including a first end joined to the one of the first connector member and the second connector member a second end electrically connected to the terminal, and a bend portion formed between the first end and the second end.

11. The prismatic battery cell according to claim 10, wherein the bend portion includes a 180° bend.

12. A method of connecting electrodes to a terminal in a prismatic battery cell, the method comprising:
positioning a plurality of terminal foils connected to an electrode stack between a first connector member and a second connector member;
applying a clamping force to the plurality of terminal foils through the first connector member and the second connector member;
connecting the plurality of terminal foils to the first connector member and the second connector member to form a connector assembly; and
joining the connector assembly to a cap of the prismatic battery cell.

13. The method of claim 12, further comprising attaching an internal terminal plate to the cap, the internal terminal plate being electrically connected with the terminal.

14. The method of claim 13, wherein joining the connector assembly to the cap includes welding the connector assembly to the internal terminal plate.

15. The method of claim 12, wherein positioning the terminal foils includes placing the terminal foils between a first leg element of a first L-shaped connector member and a third leg element of a second L-shaped connector member.

16. The method of claim 15, wherein joining the connector assembly to the cap includes joining a second leg element of the first L-shaped connector member and a fourth leg element of the second L-shaped connector member to the terminal.

17. The method of claim 15, wherein joining the connector assembly to the cap includes joining a fourth leg element of the second L-shaped connector member to the terminal, the fourth leg element including a 180° bend.

18. The method of claim 12, wherein joining the connector assembly to the cap includes
inverting the cap;
joining a first end of a connector element to one of the first connector member and the second connector member;
joining a second end of the connector element to the terminal on the cap; and
bending the connector element to invert the cap.

19. The method of claim 12, wherein joining the connector assembly to the terminal includes welding the connector assembly to a terminal block supported on the cap.

20. The method of claim 19, wherein welding the connector assembly to the terminal block includes protecting one or more of the plurality of terminal foils and the electrode stack with one of a shielding gas and a clamp shield.
